(19) United States
(12) Patent Application Publication
(10) Pub. No.: US 2025/0258139 A1
(43) Pub. Date: Aug. 14, 2025

(54) ULTRASONIC DEFECT DETECTION APPARATUS AND ULTRASONIC DEFECT DETECTION METHOD

(71) Applicant: MITSUBISHI HEAVY INDUSTRIES, LTD., Tokyo (JP)

(72) Inventors: Seiji KOBAYASHI, Tokyo (JP); Kyohei HAYASHI, Tokyo (JP); Mitsuyoshi UEMATSU, Tokyo (JP)

(73) Assignee: MITSUBISHI HEAVY INDUSTRIES, LTD., Tokyo (JP)

(21) Appl. No.: 18/857,651

(22) PCT Filed: Feb. 17, 2023
(86) PCT No.: PCT/JP2023/005729

§ 371 Date: Oct. 17, 2024

(30) Foreign Application Priority Data
Apr. 28, 2022 (JP) 2022-074353

(51) Int. Cl. G01N 29/06

(52) U.S. Cl. CPC G01N 29/0645; G01N 2291/023; G01N 2291/0289; G01N 2291/106

(57) ABSTRACT

Provided is an ultrasonic defect detection apparatus (100) including an ultrasonic array probe (10), a voltage application element (20) that executes a voltage application operation including a first operation of simultaneously applying a predetermined voltage to a predetermined number of ultrasonic elements and a second operation of dividing the predetermined number of ultrasonic elements into a plurality of element groups and applying the predetermined voltage to each of the element groups at different timings, an acquisition element (30) that acquires a differential response value, which is a difference between a first response value of ultrasonic waves of a predetermined frequency received by the ultrasonic array probe in the first operation and a second response value obtained by adding a plurality of response values of ultrasonic waves of a predetermined frequency received by the ultrasonic array probe at different timings in the second operation, and a measurement element (40) that measures an opening width of a defect (DF) based on the plurality of differential response values acquired by the acquisition element (30) when the voltage applying unit (20) executes the voltage application operation at a plurality of predetermined voltages having different voltage values.

### TECHNICAL FIELD

The present disclosure relates to an ultrasonic defect detection apparatus and an ultrasonic defect detection method.

### BACKGROUND ART

In the related art, a technique of measuring a defect such as a closed crack or a crack having a minute opening width in an inspection object using ultrasonic waves is known (for example, see Patent Document 1). Patent Document 1 discloses a technique in which a plurality of types of ultrasonic waves having mutually different amplitudes at a predetermined fundamental frequency are transmitted to an inspection object as transmission signals, ultrasonic waves reflected from the inspection object are received, and a defect of the inspection object is visualized from a difference in response intensities with respect to the different amplitudes.

### CITATION LIST

### Patent Literature

Patent Document 1: JP 6025049 B

### SUMMARY OF INVENTION

### Technical Problem

In Patent Document 1, it is possible to detect whether there is a defect having non-linearity in which the reflection intensities of the received signals are not proportional to the magnitudes of the amplitudes of the transmitted signals by visualizing the difference between the response intensities with respect to the different amplitudes. However, Patent Document 1 visualizes the difference in the response intensities with respect to the different amplitudes, and does not measure the size of the defect (for example, the opening width of a crack) itself.

The present disclosure has been made in view of such circumstances, and an object thereof is to provide an ultrasonic defect detection apparatus and an ultrasonic defect detection method that can measure an opening width of a defect having non-linear response characteristics in which a response value of a received ultrasonic wave is not proportional to a magnitude of an amplitude of a transmitted ultrasonic wave.

### Solution to Problem

In order to solve the above-described problem, the present disclosure employs the following means.

An ultrasonic defect detection apparatus according to one aspect of the present disclosure includes:
an ultrasonic array probe including a predetermined number of ultrasonic elements arranged along a predetermined direction, each of the ultrasonic elements transmitting an ultrasonic wave of a predetermined frequency to an inspection object and receiving the ultrasonic wave of the predetermined frequency reflected by the inspection object;
a voltage application element executing a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition element acquiring a differential response value, the differential response value being a difference between a first response value of the ultrasonic wave of the predetermined frequency received by the ultrasonic array probe in the first operation and a second response value obtained by adding a plurality of response values of the ultrasonic wave of the predetermined frequency received by the ultrasonic array probe at different timings in the second operation; and
a measurement element measuring an opening width of a defect in the inspection object based on a plurality of the differential response values acquired by the acquisition element when the voltage application element executes the voltage application operation at a plurality of the predetermined voltages having different voltage values.

An ultrasonic defect detection method according to one aspect of the present disclosure is an ultrasonic defect detection method for measuring an opening width of a defect in an inspection object with an ultrasonic defect detection apparatus, the ultrasonic defect detection apparatus including an ultrasonic array probe including a predetermined number of ultrasonic elements arranged along a predetermined direction, each of the ultrasonic elements transmitting an ultrasonic wave of a predetermined frequency to an inspection object and receiving the ultrasonic wave of the predetermined frequency reflected by the inspection object, the ultrasonic defect detection method including:
a voltage application process of executing a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition process of acquiring a differential response value, the differential response value being a difference between a first response value of the ultrasonic wave of the predetermined frequency received by the ultrasonic array probe in the first operation and a second response value obtained by adding a plurality of response values of the ultrasonic wave of the predetermined frequency received by the ultrasonic array probe at different timings in the second operation; and
a measurement process of measuring the opening width of the defect in the inspection object based on a plurality of the differential response values acquired in the acquisition process when the voltage application operation is executed at a plurality of the predetermined voltages having different voltage values in the voltage application process.

### Advantageous Effects of Invention

According to the present disclosure, it is possible to provide an ultrasonic defect detection apparatus and an ultrasonic defect detection method that can measure an opening width of a defect having non-linear response characteristics in which a response value of a received ultrasonic wave is not proportional to a magnitude of an amplitude of a transmitted ultrasonic wave.

### BRIEF DESCRIPTION OF DRAWINGS

FIG. 1 is a schematic configuration diagram of an ultrasonic defect detection apparatus according to a first embodiment of the present disclosure.

FIG. 2 is a flowchart illustrating a voltage application operation executed by a voltage application element.

FIG. 3 is a graph showing delay times of a voltage pulse applied to ultrasonic elements when the voltage application element executes a first operation.

FIG. 4 is a flowchart illustrating an operation of acquiring a differential response value executed by an acquisition element.

FIG. 5 is a graph showing a relationship between an amplitude of an ultrasonic wave and a response value acquired by the acquisition element.

FIG. 6 is a graph showing a relationship between a voltage value at which a linear response is transferred to a non-linear response and an opening width of a defect.

FIG. 7 is a flowchart illustrating an operation of creating a table to be stored in a storage element.

FIG. 8 is a flowchart illustrating an operation of measuring an opening width of a defect.

FIG. 9 is a perspective view illustrating a state in which an ultrasonic array probe is placed on a surface of an inspection object.

FIG. 10 is a diagram illustrating an example of a C-scan image displayed on an image display element.

FIG. 11 is a diagram illustrating an example of a C-scan image displayed on the image display element when the voltage application element switches a voltage value to be applied to the ultrasonic elements.

FIG. 12 is a flowchart illustrating a voltage application operation executed by the voltage application element.

FIG. 13 is a graph showing a relationship between an amplitude of an ultrasonic wave and a response value acquired by the acquisition element.

FIG. 14 is a front view illustrating a state in which a defect of the inspection object is scanned with an ultrasonic wave from a single ultrasonic element.

FIG. 15 is a front view illustrating a state in which a defect of the inspection object is scanned with an ultrasonic wave from a single ultrasonic element.

FIG. 16 is a front view illustrating a state in which a defect of the inspection object is scanned with an ultrasonic wave from a single ultrasonic element.

FIG. 17 is a flowchart illustrating a process in which a DC voltage applied from a DC voltage application element to the ultrasonic elements is changed so as to focus on an adhesive layer, and the voltage application element executes the voltage application operation.

### DESCRIPTION OF EMBODIMENTS

### First Embodiment

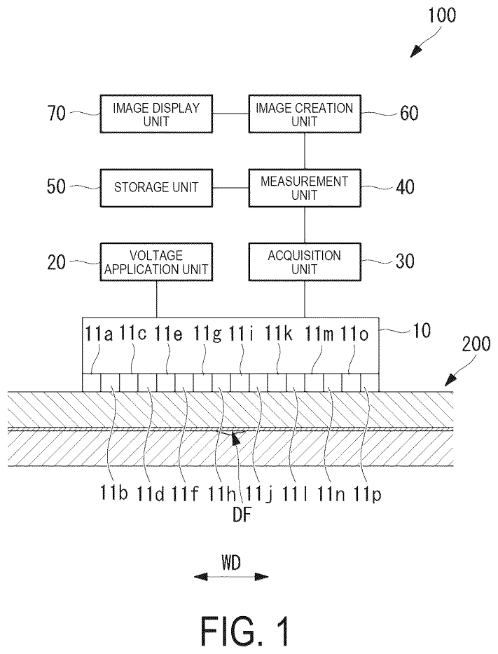

Hereinafter, an ultrasonic defect detection apparatus 100 according to a first embodiment of the present disclosure will be described with reference to the drawings. FIG. 1 is a schematic configuration diagram of the ultrasonic defect detection apparatus 100 according to the first embodiment of the present disclosure. The ultrasonic defect detection apparatus 100 of the present embodiment is an apparatus that measures an opening width of a defect DF in an inspection object 200.

As illustrated in FIG. 1, the ultrasonic defect detection apparatus 100 includes an ultrasonic array probe 10, a voltage application element 20, an acquisition element 30, a measurement element 40, a storage element 50, an image creation element 60, and an image display element 70.

The ultrasonic array probe 10 includes a predetermined number of ultrasonic elements 11a to 11p that transmit an ultrasonic wave of a predetermined frequency to the inspection object 200 and receive the ultrasonic wave of the predetermined frequency reflected by the inspection object 200. The predetermined number of ultrasonic elements 11a to 11p are arranged along a width direction (predetermined direction) WD.

FIG. 1 illustrates 16 ultrasonic elements arranged along the width direction WD, but an arbitrary number (e.g., 32, 64, or 128) of ultrasonic elements other than 16 may be arranged. The ultrasonic elements 11a to 11p receive the reflected wave of the transmitted ultrasonic wave of the predetermined frequency, output a response value corresponding to the intensity of the reflected wave, and transmit the response value to the acquisition element 30.

The voltage application element 20 applies a voltage pulse having a predetermined waveform and a predetermined frequency to the ultrasonic elements 11a to 11p to transmitan ultrasonic wave. The voltage pulse applied to the ultrasonic elements 11a to 11p by the voltage application element 20 is, for example, a spike pulse or a rectangular pulse. The voltage application element 20 executes a voltage application operation including a first operation of simultaneously applying a predetermined voltage to all the ultrasonic elements 11a to 11p and a second operation of dividing the ultrasonic elements 11a to 11p into a plurality of element groups and applying a predetermined voltage to each element group at different timings.

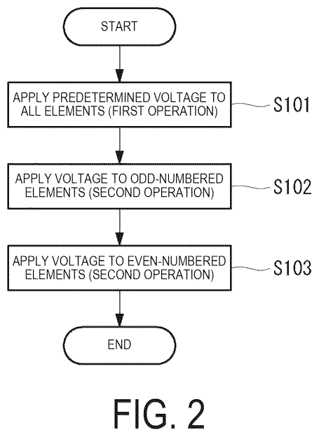

FIG. 2 is a flowchart illustrating the voltage application operation executed by the voltage application element 20.

In step S101, the voltage application element 20 executes the first operation of simultaneously applying a predetermined voltage to all the ultrasonic elements 11a to 11p. Here, “simultaneously applying” means continuously performing an operation of applying a voltage pulse to all the ultrasonic elements 11a to 11p while delaying the voltage pulse applied to the ultrasonic elements 11a to 11p by delay times.

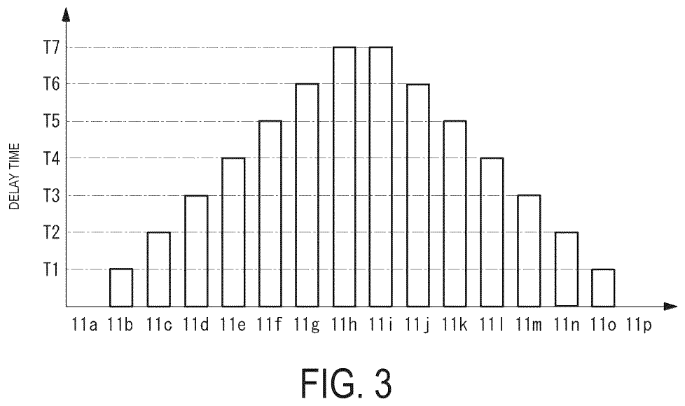

In the present embodiment, the voltage application element 20 executes the voltage application operation using a phased array excitation method so as to provide a focal point at the central portion of the ultrasonic array probe 10 in the width direction WD. FIG. 3 is a graph showing delay times of the voltage pulse applied to the ultrasonic elements 11a to 11p when the voltage application element 20 executes the first operation.

As shown in FIG. 3, the delay time of the voltage pulse applied to the ultrasonic elements 11a and 11p arranged at both ends in the width direction WD is zero. The delay time of the voltage pulse applied to the ultrasonic elements 11b and 11o is T1. The delay time of the voltage pulse applied to the ultrasonic elements 11c and 11n is T2. The delay time of the voltage pulse applied to the ultrasonic elements 11d and 11m is T3. The delay time of the voltage pulse applied to the ultrasonic elements 11e and 11l is T4. The delay time of the voltage pulse applied to the ultrasonic elements 11f and 11k is T5. The delay time of the voltage pulse applied to the ultrasonic elements 11g and 11j is T6. The delay time of the voltage pulse applied to the ultrasonic elements 11h and 11i is T7.

As shown in FIG. 3, with respect to the voltage pulse applied to the ultrasonic elements 11a and 11p arranged at both ends in the width direction WD, the shorter the distance to the central portion in the width direction WD, the longer the delay time of the voltage pulse applied to the ultrasonic elements.

In the first operation in step S101, the reflected waves of the ultrasonic waves transmitted by all the ultrasonic elements 11a to 11p are received by the ultrasonic elements 11a to 11p. The ultrasonic array probe 10 calculates a response value by performing a binning process of integrating 16 output values obtained by the ultrasonic elements 11a to 11p receiving the reflected waves, and outputs the response value to the acquisition element 30.

In step S102 and step S103, the voltage application element 20 executes the second operation of dividing the ultrasonic elements 11a to 11p into a plurality of element groups and applying a predetermined voltage to each of the element groups at different timings.

In step S102, the voltage application element 20 simultaneously applies the predetermined voltage to a first element group including 8 odd-numbered ultrasonic elements 11a, 11c, 11e, 11g, 11i, 11k, 11m, and 11o from one end in the width direction WD among the plurality of ultrasonic elements 11a to 11p. Here, “simultaneously applies” means continuously performing an operation of applying a voltage pulse to the odd-numbered ultrasonic elements 11a, 11c, 11e, 11g, 11i, 11k, 11m, and 11o while delaying the voltage pulse applied to the odd-numbered ultrasonic elements 11a, 11c, 11e, 11g, 11i, 11k, 11m, and 110 by the delay times. In step S102, the voltage application element 20 does not apply the predetermined voltage to the even-numbered ultrasonic elements 11b, 11d, 11f, 11h, 11j, 11l, 11n, and 11p.

In step S103, the voltage application element 20 simultaneously applies the predetermined voltage to a second element group including 8 even-numbered ultrasonic elements 11b, 11d, 11f, 11h, 11j, 11l, 11n, and 11p from one end in the width direction WD among the plurality of ultrasonic elements 11a to 11p. Here, “simultaneously applies” means continuously performing an operation of applying a voltage pulse to the even-numbered ultrasonic elements 11b, 11d, 11f, 11h, 11j, 11l, 11n, and 11p while delaying the voltage pulse applied to the even-numbered ultrasonic elements 11b, 11d, 11f, 11h, 11j, 11l, 11n, and 11p by the delay times. In step S103, the voltage application element 20 does not apply the predetermined voltage to the odd-numbered ultrasonic elements 11a, 11c, 11e, 11g, 11i, 11k, 11m, and 11o.

In the second operation including step S102 and step S103, the reflected waves of the ultrasonic waves transmitted by the odd-numbered ultrasonic elements 11a, 11c, 11e, 11g, 11i, 11k, 11m, and 11o are received by the ultrasonic elements 11a to 11p. A response value is calculated by performing a binning process of integrating 16 output values obtained by the ultrasonic elements 11a to 11p receiving the reflected waves, and the response value is output to the acquisition element 30.

In addition, in the second operation, the reflected waves of the ultrasonic waves transmitted by the even-numbered ultrasonic elements 11b, 11d, 11f, 11h, 11j, 11l, 11n, and 11p are received by the ultrasonic elements 11a to 11p. A response value is calculated by performing a binning process of integrating 16 output values obtained by the ultrasonic elements 11a to 11p receiving the reflected waves, and the response value is output to the acquisition element 30.

The acquisition element 30 acquires a first response value of the ultrasonic waves of the predetermined frequency received by the ultrasonic array probe 10 in the first operation of the voltage application element 20 and a second response value obtained by adding a plurality of response values of the ultrasonic waves of the predetermined frequency received by the ultrasonic array probe 10 at different timings in the second operation of the voltage application element 20, and acquires a differential response value which is a difference between the first response value and the second response value.

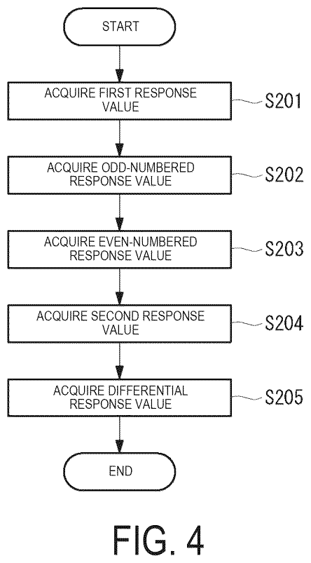

FIG. 4 is a flowchart illustrating an operation of acquiring a differential response value executed by the acquisition element 30.

In step S201, when the voltage application element 20 executes the first operation, the acquisition element 30 acquires a response value (first response value) output from the ultrasonic array probe 10 with respect to the reflected waves of the ultrasonic waves transmitted by the ultrasonic elements 11a to 11p.

In step S202, when the voltage application element 20 executes the second operation, the acquisition element 30 acquires an odd-numbered response value corresponding the odd-numbered ultrasonic elements output from the ultrasonic array probe 10 with respect to the reflected waves of the ultrasonic waves transmitted by the odd-numbered ultrasonic elements 11a, 11c, 11e, 11g, 11i, 11k, 11m, and 11o.

In step S203, when the voltage application element 20 executes the second operation, the acquisition element 30 acquires an even-numbered response value corresponding to the even-numbered ultrasonic elements output from the ultrasonic array probe 10 with respect to the reflected waves of the ultrasonic waves transmitted by the even-numbered ultrasonic elements 11b, 11d, 11f, 11h, 11j, 11l, 11n, and 11p.

In step S204, the acquisition element 30 adds the odd-numbered response value corresponding to the odd-numbered ultrasonic elements and the even-numbered response value corresponding to the even-numbered ultrasonic elements to obtain an added response value (second response value).

In step S205, the acquisition element 30 acquires a differential response value which is a difference between the first response value and the second response value.

As described above, the acquisition element 30 acquires the differential response value which is a difference between the first response value of the ultrasonic waves of the predetermined frequency received by the ultrasonic array probe 10 in the first operation of the voltage application element 20 and the second response value obtained by adding a plurality of response values (the odd-numbered response value corresponding to the odd-numbered ultrasonic elements and the even-numbered response value corresponding to the even-numbered ultrasonic elements) of the ultrasonic waves of the predetermined frequency received by the ultrasonic array probe 10 at different timings in the second operation of the voltage application element 20.

The measurement element 40 measures an opening width of a defect DF in the inspection object 200 based on a plurality of the differential response values acquired by the acquisition element 30 when the voltage application element 20 executes the voltage application operation at a plurality of the predetermined voltages having different voltage values.

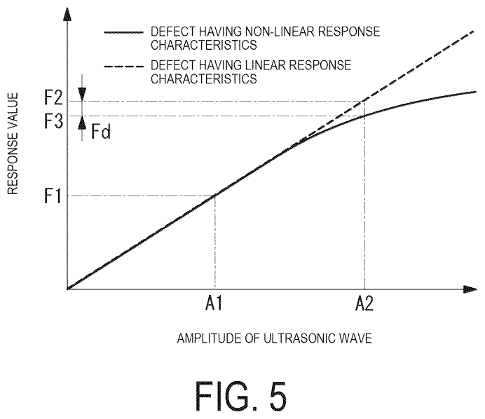

Here, the relationship between an amplitude of an ultrasonic wave and a response value acquired by the acquisition element 30 will be described with reference to FIG. 5. FIG. 5 is a graph showing the relationship between an amplitude of an ultrasonic wave and a response value acquired by the acquisition element 30. In FIG. 5, a solid line indicates a defect in which the opening width of the defect DF of the inspection object 200 is minute and which exhibits non-linear response characteristics. A dotted line indicates a defect in which the opening width of the defect DF of the inspection object 200 is large and which exhibits linear response characteristics.

In FIG. 5, an amplitude A2 indicates an example of the amplitude of the ultrasonic waves output from the ultrasonic elements 11a to 11p when the voltage application element 20 executes the first operation. An amplitude A1 indicates an example of the amplitude of the ultrasonic waves output from the odd-numbered ultrasonic elements 11a, 11c, 11e, 11g, 11i, 11k, 11m, and 11o or the even-numbered ultrasonic elements 11b, 11d, 11f, 11h, 11j, 11l, 11n, and 11p when the voltage application element 20 executes the second operation.

In the case where the defect DF has linear response characteristics in which the magnitude of the response value of the reflected ultrasonic waves is proportional to the magnitude of the amplitude of the ultrasonic waves transmitted from the ultrasonic elements 11a to 11p, since the second operation uses half of the number of the ultrasonic elements used in the first operation, the amplitude A1 is substantially half the amplitude A2. The response value acquired by the acquisition element 30 with respect to the ultrasonic waves having the amplitude A1 is F1, and the response value acquired by the acquisition element 30 with respect to the ultrasonic waves having the amplitude A2 is F2. Since the response value F1 is substantially half the response value F2, the differential response value is zero or a minute value.

This is because, in the case of the defect DF having linear response characteristics, the first response value (F2) obtained by adding response values output from the ultrasonic elements 11a to 11p when the voltage application element 20 executes the first operation is substantially the same as the second response value (F1×2) obtained by adding response values output from the ultrasonic elements 11a to 11p when the voltage application element 20 executes the second operation.

On the other hand, in the case where the defect DF having non-linear response characteristics in which the magnitude of the response value of the reflected ultrasonic waves is not proportional to the magnitude of the amplitude of the ultrasonic waves transmitted from the ultrasonic elements 11a to 11p, the response value acquired by the acquisition element 30 with respect to the ultrasonic waves having the amplitude A2 is F3 which is smaller than F2. The value obtained by subtracting F3 from F2 is a differential response value Fd. As shown in FIG. 5, the differential response value Fd increases as the magnitude of the amplitude increases.

This is because, in the case of the defect DF having non-linear response characteristics, the first response value (F3) obtained by adding response values output from the ultrasonic elements 11a to 11p when the voltage application element 20 executes the first operation is smaller than the second response value (F1×2=F2) obtained by adding response values output from the ultrasonic elements 11a to 11p when the voltage application element 20 executes the second operation.

The reason why the first response value is smaller than the second response value in the case of the defect DF having non-linear response characteristics is that the energy of the ultrasonic waves output from all of the ultrasonic elements 11a to 11p with respect to the defect DF of the inspection object 200 is large, and a part of the opening (crack surface) of the defect DF is closed to come into contact, and whereby part of the ultrasonic waves is not reflected.

The defect DF having non-linear response characteristics exhibits linear response characteristics when the amplitude is small, but exhibits non-linear response characteristics when the amplitude increases. In addition, the larger the opening width of the defect DF is, the larger the amplitude (a voltage applied by the voltage application element 20) at the time of transferring from a state indicating linear response characteristics to a state indicating non-linear response characteristics is.

Thus, the ultrasonic defect detection apparatus 100 of the present embodiment acquires a plurality of the differential response values acquired by the acquisition element 30 when the voltage application element 20 executes the voltage application operation at a plurality of the predetermined voltages having different voltage values, and refers to the voltage value of the predetermined voltage applied by the voltage application element 20 when the differential response value becomes a predetermined threshold value, thereby measuring the opening width of the defect DF in the inspection object 200.

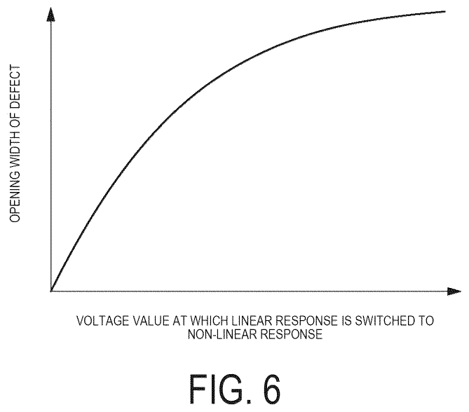

Specifically, the table shown in FIG. 6 is acquired using a test piece having the same structure and material as those of the inspection object 200 and stored in the storage element 50 in advance. Then, the measurement element 40 refers to the table to obtain the opening width of the defect DF from the voltage value of the predetermined voltage applied by the voltage application element 20 when the differential response value acquired by the acquisition element 30 becomes the predetermined threshold value.

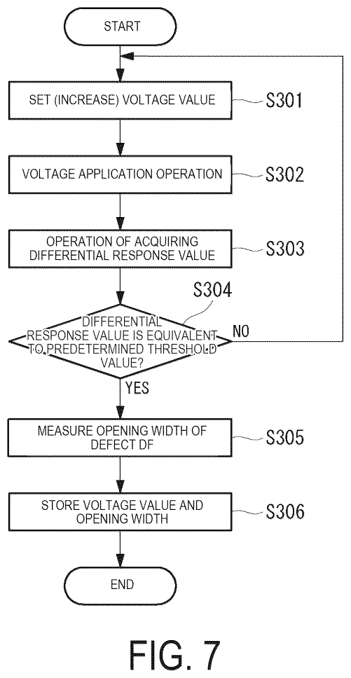

Next, an operation of creating a table to be stored in the storage element 50 will be described with reference to FIG. 7. FIG. 7 is a flowchart illustrating the operation of creating a table to be stored in the storage element 50.

When the flowchart illustrated in FIG. 7 is executed, the storage element 50 stores a table associating a voltage value of a predetermined voltage applied by the voltage application element 20 when a differential response value acquired by the acquisition element 30 becomes a predetermined threshold value and an opening width of the defect DF in the inspection object 200.

In step S301, the voltage application element 20 sets a voltage value of a predetermined voltage to be applied to the ultrasonic elements 11a to 11p. When this setting is executed immediately after the start of this flowchart, the voltage application element 20 sets a voltage value at which the defect DF reliably exhibits linear response characteristics as the voltage value of the predetermined voltage. This is to search for a voltage value at which a state indicating linear response characteristics is transferred to a state indicating non-linear response characteristics by gradually increasing the voltage value of the predetermined voltage.

In step S302, the voltage application element 20 executes the voltage application operation illustrated in FIG. 2 at the voltage value of the predetermined voltage set in step S301.

In step S303, the acquisition element 30 executes the operation of acquiring a differential response value illustrated in FIG. 4.

In step S304, the acquisition element 30 determines whether the differential response value acquired in step S303 is a predetermined threshold value. If YES, the processing proceeds to step S305, and if NO, the processing from step S301 is executed again. Note that, in step S304, when the differential response value exceeds the predetermined threshold value, it may be determined that the differential response value acquired in step S303 is the predetermined threshold value.

When step S301 is executed again, the voltage application element 20 increases the voltage value of the predetermined voltage. This is because the differential response value acquired in step S303 is not the predetermined threshold value and the defect DF is in a state of exhibiting linear response characteristics, and thus a voltage value at which the defect DF is transferred to a state of exhibiting non-linear response characteristics is searched for.

When the differential response value acquired in step S303 is the predetermined threshold value, it is understood that the present voltage value of the predetermined voltage is a voltage value at which the state indicating linear response characteristics is transferred to the state indicating non-linear response characteristics. Thus, in step S305, the opening width of the defect DF is measured with a laser displacement meter (not illustrated) or the like.

In step S306, the voltage value of the predetermined voltage applied by the voltage application element 20 when YES is determined in step S304 and the opening width of the defect DF measured in step S305 are associated with each other and stored in the storage element 50 as data of the table, and the flowchart is ended.

The processing of this flowchart is executed for each of a plurality of test pieces having different opening widths of defects, and a plurality of sets of data in which a voltage value of a predetermined voltage and a measurement value of an opening width of a defect are associated with each other is stored in the storage element 50. In addition, in order to enable the measurement element 40 to measure (estimate) the opening width of the defect DF which has not been measured with a test piece, the table stored in the storage element 50 may be complemented as a function indicated by a straight line in FIG. 5 for a region in which there is no data associating a voltage value and an opening width of the defect DF with each other.

The defect DF that can be measured with a laser displacement meter (not illustrated) or the like needs to be exposed at a surface of a test piece. Thus, the test piece having a surface at which the defect DF is exposed is used. However, the defect DF actually measured by the ultrasonic defect detection apparatus 100 may not be exposed at a surface of the inspection object 200.

Thus, when the defect DF that is not exposed at a surface of the inspection object 200 is actually measured by the ultrasonic defect detection apparatus 100, the table obtained through the processing of this flowchart is corrected by using an analysis model of the defect DF that is not exposed at a surface of the inspection object 200, and stored in the storage element 50.

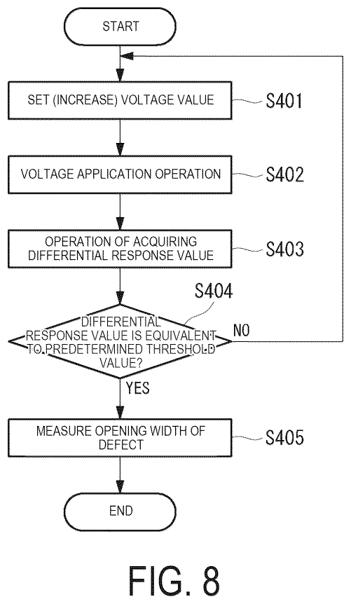

Next, an operation of measuring the opening width of the defect DF will be described with reference to FIG. 8. FIG. 8 is a flowchart illustrating the operation of measuring the opening width of the defect DF.

In step S401, the voltage application element 20 sets a voltage value of a predetermined voltage to be applied to the ultrasonic elements 11a to 11p. When this setting is executed immediately after the start of this flowchart, the voltage application element 20 sets a voltage value at which the defect DF reliably exhibits linear response characteristics as the voltage value of the predetermined voltage. This is to search for a voltage value at which a state indicating linear response characteristics is transferred to a state indicating non-linear response characteristics by gradually increasing the voltage value of the predetermined voltage.

In step S402, the voltage application element 20 executes the voltage application operation illustrated in FIG. 2 at the voltage value of the predetermined voltage set in step S401.

In step S403, the acquisition element 30 executes the operation of acquiring a differential response value illustrated in FIG. 4.

In step S404, the acquisition element 30 determines whether the differential response value acquired in step S403 is a predetermined threshold value. If YES, the processing proceeds to step S405, and if NO, the processing from step S401 is executed again. Note that, in step S404, when the differential response value exceeds the predetermined threshold value, it may be determined that the differential response value acquired in step S403 is the predetermined threshold value.

When step S401 is executed again, the voltage application element 20 increases the voltage value of the predetermined voltage. This is because the differential response value acquired in step S403 is not the predetermined threshold value and the defect DF is in a state of exhibiting linear response characteristics, and thus a voltage value at which the defect DF is transferred to a state of exhibiting non-linear response characteristics is searched for. In this way, the voltage application element 20 executes the voltage application operation a plurality of times by switching the voltage value of the predetermined voltage such that the differential response value acquired by the acquisition element 30 becomes the predetermined threshold value.

When the differential response value acquired in step S403 is the predetermined threshold value, it is understood that the present voltage value of the predetermined voltage is a voltage value at which the state indicating linear response characteristics is transferred to the state indicating non-linear response characteristics.

In step S405, the measurement element 40 measures the opening width based on the voltage value of the predetermined voltage applied by the voltage application element 20 when the differential response value acquired by the acquisition element 30 becomes the predetermined threshold value and the table stored in the storage element 50. The measurement element 40 outputs the opening width corresponding to the voltage value by referring to the table stored in the storage element 50. For example, the measurement element 40 displays the measured opening width at the image display element 70. Through steps S401 to S405 described above, the opening width of the defect DF present at the location of the focal point can be measured at the position where the ultrasonic array probe 10 is currently arranged. Further, by moving the ultrasonic array probe 10 to an arbitrary position on a surface of the inspection object 200, the opening width of the defect DF at the arbitrary position on the surface of the inspection object 200 can be measured.

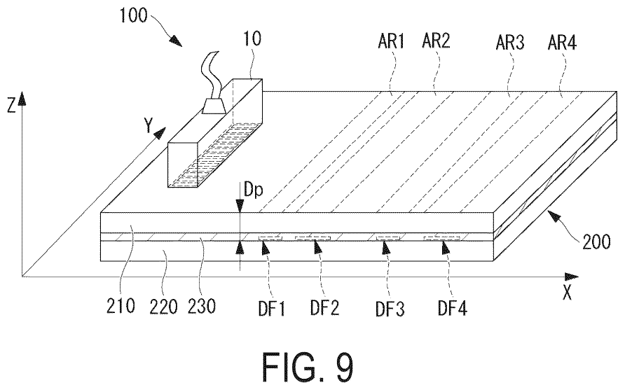

FIG. 9 is a perspective view illustrating a state in which the ultrasonic array probe 10 of the present embodiment is installed at a surface of the inspection object 200. The inspection object 200 illustrated in FIG. 9 is made by joining a pair of plate-like members 210 and 220 formed of carbon fiber reinforced plastic (CFRP) with an adhesive 230.

In the inspection object 200, the adhesive 230 is disposed at a position Dp in the Z-axis direction (depth direction) from a surface of the plate-like member 210. The defect DF may occur in the position in the Z-axis direction where the adhesive 230 is disposed. Thus, for the ultrasonic array probe 10, the focal point of the ultrasonic waves is set at the position Dp in the Z-axis direction from the surface of the plate-like member 210.

In FIG. 9, the direction in which the ultrasonic elements 11a to 11p are arranged in the ultrasonic array probe 10 is a direction along the Y axis. The ultrasonic defect detection apparatus 100 moves the ultrasonic array probe 10 along the X axis orthogonal to the Y axis so that the acquisition element 30 acquires a differential response value at each position on the X axis of the inspection object 200 and the measurement element 40 measures the opening width of the defect DF. Note that the ultrasonic defect detection apparatus 100 may move the ultrasonic array probe 10 along the Y axis so that the acquisition element 30 acquires a differential response value at each position on the Y axis of the inspection object 200 and the measurement element 40 measures the opening width of the defect DF.

The ultrasonic defect detection apparatus 100 can acquire a differential response value at each position on the Y axis of the inspection object 200 and measure the opening width in an area of the inspection object 200 which is in contact with the ultrasonic array probe 10, without moving the ultrasonic array probe 10 along the Y axis.

Specifically, it is possible to acquire differential response values by using a selected part of the ultrasonic elements 11a to 11p (e.g., 8 sequentially-arranged ultrasonic elements out of 16 ultrasonic elements) and measure the opening width. By moving the combination of the selected part of the ultrasonic elements along the Y axis, it is possible to acquire a differential response value at each position on the Y axis of the inspection object 200 and measure the opening width in the area of the inspection object 200 which is in contact with the ultrasonic array probe 10.

The image creation element 60 creates a C-scan image, which is a two-dimensional image, from differential intensities acquired by the acquisition element 30 when the ultrasonic array probe 10 is moved on the surface of the inspection object 200 along the X-axis direction (movement direction). The image display element 70 displays the C-scan image created by the image creation element 60.

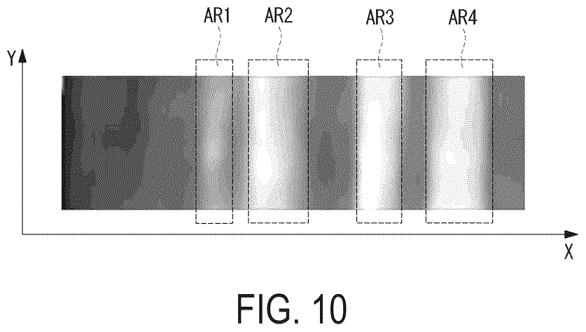

FIG. 10 is a diagram illustrating an example of a C-scan image displayed on the image display element 70. In the grayscale image illustrated in FIG. 10, the darker color indicates the smaller differential response value, and the lighter color indicates the larger differential response value. Areas AR1, AR2, AR3, and AR4 illustrated in FIGS. 9 and 10 indicate areas on the XY plane of the inspection object 200. The areas AR1, AR2, AR3, and AR4 respectively correspond to the positions of defects DF1, DF2, DF3, and DF4 present in the area where the adhesive 230 is disposed. From the C-scan image illustrated in FIG. 10, it is possible to visually recognize at which position on the XY plane of the inspection object 200 the defect DF is present.

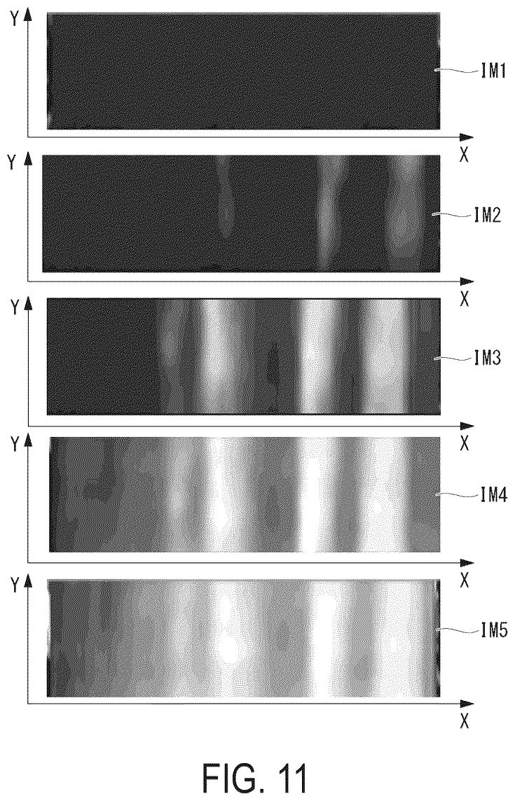

FIG. 11 is a diagram illustrating an example of a C-scan image displayed on the image display element 70 when the voltage application element 20 switches the voltage value applied to the ultrasonic elements 11a to 11p. Images IM1, IM2, IM3, IM4, and IM5 illustrated in FIG. 11 are C-scan images when the voltage application element 20 applies a first voltage V1, a second voltage V2, a third voltage V3, a fourth voltage V4, and a fifth voltage V5. There is a relationship of the first voltage V1<the second voltage V2<the third voltage V3<the fourth voltage V4<the fifth voltage V5.

As illustrated in FIG. 11, in the image IM1 obtained when the first voltage V1 is applied, the color is the darkest in almost all the areas of the inspection object 200, indicating that the differential response value is 0 or a minute value. On the other hand, in the image IM2 obtained when the second voltage V2 is applied, the color is lighter than in the image IM1 in a part of the areas of the inspection object 200. This is because the differential response value has increased in the part of the areas of the inspection object 200.

Then, as the voltage applied to the ultrasonic elements 11a to 11p is increased to the third voltage V3, the fourth voltage V4, and the fifth voltage V5, the differential response value at each position on the XY plane increases, and the color of a part of the areas of the inspection object 200 becomes even lighter. In the present embodiment, the opening width of the defect DF in the inspection object 200 can be measured by the measurement element 40 by focusing on such a change in the color density.

The operations and effects of the ultrasonic defect detection apparatus 100 of the present embodiment described above will be described.

According to the ultrasonic defect detection apparatus 100 of the present embodiment, when the voltage application element 20 executes the voltage application operation including the first operation and the second operation, the acquisition element 30 acquires a differential response value that is a difference between the first response value received by the ultrasonic array probe 10 in the first operation and the second response value obtained by adding a plurality of response values received by the ultrasonic array probe 10 in the second operation.

In the case of a defect exhibiting linear response characteristics in which the magnitude of a response value of reflected ultrasonic waves is proportional to the magnitude of the amplitude of ultrasonic waves transmitted from the ultrasonic elements, the differential response value is zero or a minute value. On the other hand, in the case of a defect exhibiting non-linear response characteristics in which the magnitude of a response value of reflected ultrasonic waves is not proportional to the magnitude of the amplitude of ultrasonic waves transmitted from the ultrasonic elements, the differential response value increases as the magnitude of the amplitude increases. The defect having non-linear response characteristics exhibits a linear response when the amplitude is small, but exhibits non-linear response characteristics when the amplitude increases.

Thus, the ultrasonic defect detection apparatus 100 of the present embodiment is configured to measure the opening width of the defect DF in the inspection object 200 based on a plurality of the differential response values acquired by the acquisition element 30 when the voltage application element 20 executes the voltage application operation at a plurality of the predetermined voltages having different voltage values. For example, when the voltage application element 20 executes the voltage application operation at the plurality of predetermined voltages while increasing the voltage value, the voltage value of the predetermined voltage at which the differential response value starts to increase is determined, whereby the opening width corresponding to the determined voltage value can be output as a measurement value.

Further, according to the ultrasonic defect detection apparatus 100 of the present embodiment, the storage element 50 stores a table associating a voltage value of a predetermined voltage applied by the voltage application element 20 when a differential response value acquired by the acquisition element 30 becomes a predetermined threshold value (e.g., a value reliably indicating that a non-linear response is exhibited) and an opening width of the defect DF in the inspection object 200. Then, the measurement element 40 can measure the opening width based on the voltage value of the predetermined voltage applied by the voltage application element 20 when the differential response value acquired by the acquisition element 30 becomes the predetermined threshold value and the table stored in the storage element 50.

According to the ultrasonic defect detection apparatus 100 of the present embodiment, each of a response value received by applying the predetermined voltage to the odd-numbered first element group and a response value received by applying the predetermined voltage to the even-numbered second element group is half a response value received by applying the predetermined voltage to all the elements. Thus, when the first response value received in the first operation exhibits non-linear response characteristics, the differential response value can be acquired such that each response value received when the predetermined voltage is applied to the first element group or the second element group exhibits linear response characteristics.

According to the ultrasonic defect detection apparatus 100 of the present embodiment, by creating a C-scan image with the image creation element 60, an image of the inspection object 200 along the movement direction can be displayed, making it possible to easily recognize a position in the movement direction at which a defect has occurred.

### Second Embodiment

Next, the ultrasonic defect detection apparatus 100 according to a second embodiment of the present disclosure will be described. The present embodiment is a modification of the first embodiment, and is assumed to be the same as the first embodiment unless otherwise described below.

In the ultrasonic defect detection apparatus 100 of the first embodiment, the voltage application element 20 executes the second operation of dividing the ultrasonic elements 11a to 11p into the even-numbered first element group and the odd-numbered second element group and applying a predetermined voltage to each element group at different timings. In contrast, in the ultrasonic defect detection apparatus 100 of the present embodiment, the voltage application element 20 applies a predetermined voltage to each of the ultrasonic elements 11a to 11p at different timings.

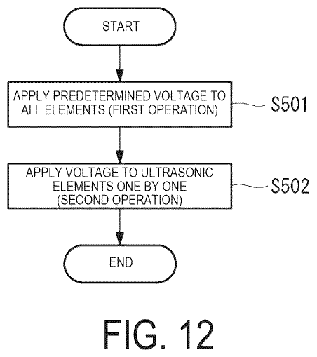

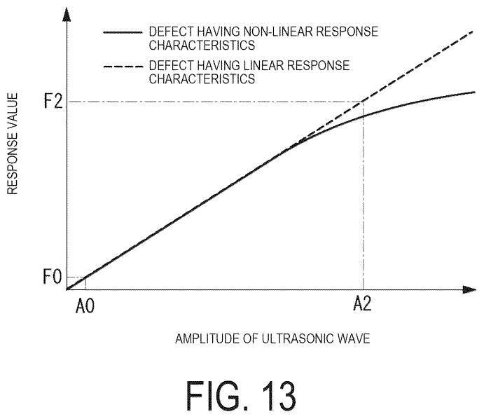

FIG. 12 is a flowchart illustrating the voltage application operation executed by the voltage application element 20. FIG. 13 is a graph showing a relationship between an amplitude of ultrasonic waves and a response value acquired by the acquisition element 30.

As illustrated in FIG. 12, in step S501, the voltage application element 20 executes a first operation of simultaneously applying a predetermined voltage to all the ultrasonic elements 11a to 11p. Here, “simultaneously applying” means continuously performing an operation of applying a voltage pulse to all the ultrasonic elements 11a to 11p while delaying the voltage pulse applied to the ultrasonic elements 11a to 11p by delay times.

In step S502, the voltage application element 20 executes a second operation of applying a predetermined voltage to each of the ultrasonic elements 11a to 11p at different timings. The second operation is configured such that the predetermined voltage is applied to only one ultrasonic element and a response value of a reflected wave of an ultrasonic wave transmitted from the one ultrasonic element is acquired with the acquisition element 30 at all the ultrasonic elements 11a to 11p, and this operation is repeated by the number of the ultrasonic elements.

When the voltage application element 20 executes the first operation, the acquisition element 30 of the present embodiment acquires a response value (first response value) obtained by performing a binning process on the output values from the ultrasonic elements 11a to 11p with respect to the reflected waves of the ultrasonic waves transmitted by the ultrasonic elements 11a to 11p. When the voltage application element 20 executes the second operation, the acquisition element 30 repeats an operation of acquiring a response value obtained by performing a binning process on the output values from the ultrasonic elements 11a to 11p with respect to the reflected waves of the ultrasonic waves transmitted by the ultrasonic elements 11a to 11p by the number of the ultrasonic elements, thereby obtaining an added response value (second response value).

Then, the acquisition element 30 acquires a differential response value which is a difference between the first response value and the second response value. As in the first embodiment, the measurement element 40 measures the opening width of the defect DF in the inspection object 200 based on a plurality of the differential response values acquired by the acquisition element 30 when the voltage application element 20 executes the voltage application operation at a plurality of the predetermined voltages having different voltage values.

In FIG. 13, an amplitude A2 indicates an example of the amplitude of ultrasonic waves output from the ultrasonic elements 11a to 11p when the voltage application element 20 executes the first operation. On the other hand, an amplitude A0 indicates an example of the amplitude of ultrasonic waves output from any one of the ultrasonic elements 11a to 11p when the voltage application element 20 executes the second operation.

In the case where the defect DF has linear response characteristics in which the magnitude of the response value of the reflected ultrasonic waves is proportional to the magnitude of the amplitude of the ultrasonic waves transmitted from the ultrasonic elements 11a to 11p, since the second operation uses 1/16 of the number of the ultrasonic elements used in the first operation, the amplitude A0 is substantially 1/16 of the amplitude A2. The response value acquired by the acquisition element 30 with respect to the ultrasonic waves having the amplitude A0 is F0, and the response value acquired by the acquisition element 30 with respect to the ultrasonic waves having the amplitude A2 is F2. Since the response value F0 is substantially 1/16 of the response value F2, the differential response value is zero or a minute value.

This is because, in the case of the defect DF having linear response characteristics, the first response value (F2) obtained by adding response values output from the ultrasonic elements 11a to 11p when the voltage application element 20 executes the first operation is substantially the same as the second response value (F0×16) obtained by adding response values output one by one from the ultrasonic elements 11a to 11p when the voltage application element 20 executes the second operation.

As shown in FIG. 13, the amplitude A0 is extremely small at about 1/16 of the amplitude A2, and a difference in energy between the amplitude A2 and the amplitude A0 is large. Thus, the response value F0 at the amplitude A0 which serves as a reference for calculating the differential response value can be reliably made to have linear response characteristics. Since the response value F0 exhibits linear response characteristics, an error in the differential response value is reduced, and an S/N ratio can be improved.

According to the ultrasonic defect detection apparatus 100 of the present embodiment, the predetermined voltage is applied to each of the predetermined number of ultrasonic elements 11a to 11p at different timings, and the second response value is obtained by adding the predetermined number of response values which are obtained by performing a binning process on the output values from the predetermined number of ultrasonic elements 11a to 11p. The response value F0 received by applying the predetermined voltage to each of the ultrasonic elements 11a to 11p is substantially 1/16 of the response value received by applying the predetermined voltage to all the elements. Thus, when the first response value received in the first operation exhibits non-linear response characteristics, it is possible to improve the S/N ratio of the differential response value by making each response value received when the predetermined voltage is applied to each ultrasonic element to exhibit linear response characteristics.

### Third Embodiment

Next, the ultrasonic defect detection apparatus 100 according to a third embodiment of the present disclosure will be described. The present embodiment is a modification of the second embodiment, and is assumed to be the same as the second embodiment unless otherwise described below.

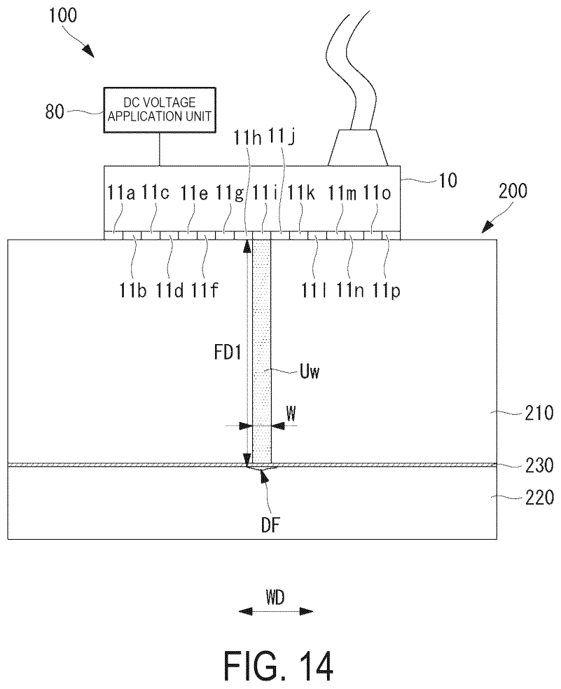

In the ultrasonic defect detection apparatus 100 of the present embodiment, each of the plurality of ultrasonic elements 11a to 11p included in the ultrasonic array probe 10 includes an adjustment mechanism for adjusting a focal length. FIGS. 14 to 16 are front views illustrating a state in which an ultrasonic wave Uw is emitted from the single ultrasonic element 11i to the defect DF of the inspection object 200.

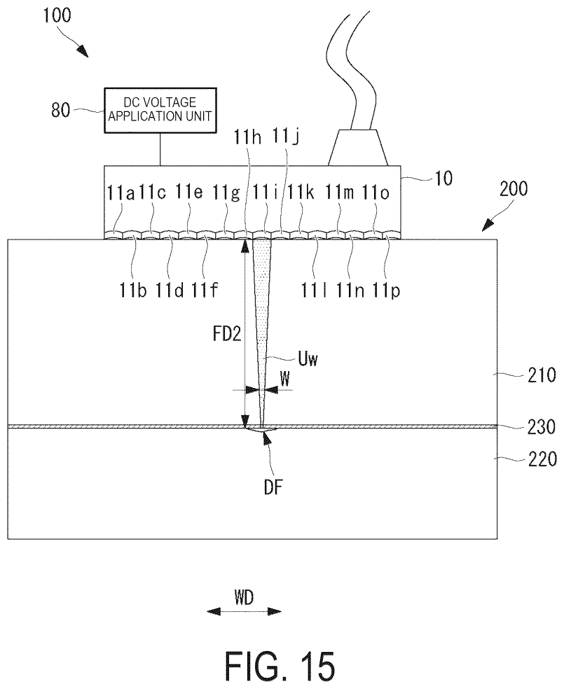

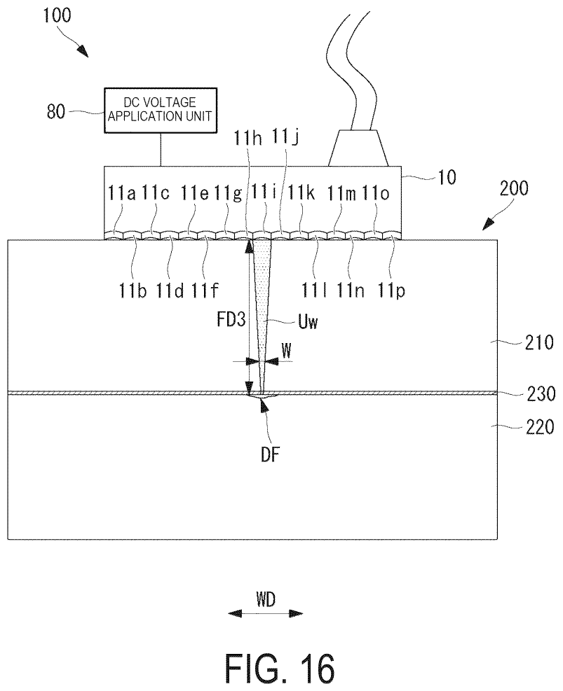

Each of the plurality of ultrasonic elements 11a to 11p of the present embodiment includes an adjustment mechanism such as a piezoelectric element that bends the shape of an inside surface in accordance with the magnitude of a DC voltage applied from a DC voltage application element 80 to adjust a focal length from the ultrasonic array probe 10 to the location of a focal point. A DC voltage Vd2 applied to the single ultrasonic element 11i from the DC voltage application element 80 illustrated in FIG. 15 is larger than a DC voltage Vd1 applied to the single ultrasonic element 11i from the DC voltage application element 80 illustrated in FIG. 14. In addition, a DC voltage Vd3 applied to the single ultrasonic element 11i from the DC voltage application element 80 illustrated in FIG. 16 is larger than the DC voltage Vd2 applied to the single ultrasonic element 11i from the DC voltage application element 80 illustrated in FIG. 15.

As illustrated in FIGS. 14 to 16, when the DC voltage applied to the single ultrasonic element 11i increases, the inside surfaces of the ultrasonic elements 11a to 11p are deformed to be concave surfaces, and the curvature radii of the concave surfaces decrease depending on the voltage. Thus, a focal length FD2 in FIG. 15 is shorter than a focal length FD1 in FIG. 14, and a focal length FD3 in FIG. 16 is shorter than the focal length FD2 in FIG. 15.

As illustrated in FIG. 14, when the DC voltage applied to the single ultrasonic element 11i is Vd1, an irradiation width W of the ultrasonic wave Uw is constant regardless of the distance from the ultrasonic element 11i. On the other hand, as illustrated in FIGS. 15 and 16, when the DC voltage applied to the single ultrasonic element 11i is Vd2 or Vd3, the irradiation width W of the ultrasonic wave Uw becomes shorter as the distance from the ultrasonic element Ili becomes longer.

FIGS. 14 to 16 illustrate an example in which the DC voltage is applied from the DC voltage application element 80 to the ultrasonic element 11i, but the DC voltage can be selectively applied from the DC voltage application element 80 to any one of the ultrasonic elements 11a to 11p. By switching the ultrasonic element to which the DC voltage is to be applied by the DC voltage application element 80, ultrasonic waves can be transmitted at an arbitrary position in the width direction WD.

For example, when the distance from the surface of the plate-like member 210 to an adhesive layer at which the adhesive 230 is present is known, the ultrasonic defect detection apparatus 100 of the present embodiment adjusts the DC voltage to be applied from the DC voltage application element 80 to the ultrasonic element so as to focus on the adhesive layer. Then, by switching the ultrasonic element to which the DC voltage is to be applied by the DC voltage application element 80, ultrasonic waves can be transmitted from an arbitrary position in the width direction WD to the adhesive layer and reflected waves reflected by the adhesive layer can be received by the ultrasonic elements 11a to 11p.

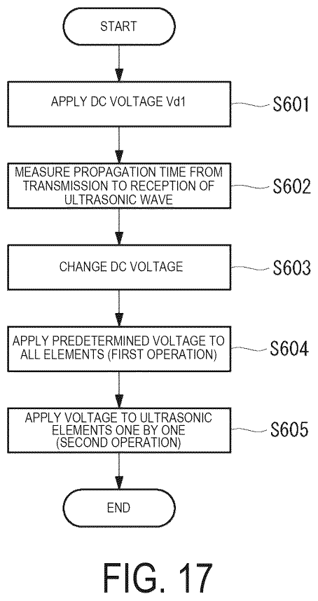

For example, even when the distance from the surface of the plate-like member 210 to the adhesive layer at which the adhesive 230 is present is not known, the ultrasonic defect detection apparatus 100 of the present embodiment can change the DC voltage to be applied from the DC voltage application element 80 to the ultrasonic element so as to focus on the adhesive layer. FIG. 17 is a flowchart illustrating a process in which the DC voltage to be applied from the DC voltage application element 80 to the ultrasonic element is changed so as to focus on the adhesive layer and the voltage application element executes the voltage application operation.

In step S601, the DC voltage application element 80 applies the DC voltage Vd1 to the single ultrasonic element Ili so that the irradiation width W of the ultrasonic wave Uw becomes constant regardless of the distance from the ultrasonic element 11i.

In step S602, the ultrasonic array probe 10 causes the voltage application element 20 to apply a predetermined voltage to the ultrasonic element 11i to transmit ultrasonic waves and measures a propagation time from when the ultrasonic element Ili transmits the ultrasonic waves to when the ultrasonic element 11i receives the ultrasonic waves.

In step S603, the ultrasonic array probe 10 detects the distance from the plate-like member 210 to the adhesive layer at which the ultrasonic waves are reflected, based on a known ultrasonic wave propagation speed in the plate-like member 210 and the propagation time measured in step S602. Then, the ultrasonic array probe 10 changes the DC voltage to be applied from the DC voltage application element 80 to the ultrasonic element so as to focus on the adhesive layer.

In step S604, the voltage application element 20 executes a first operation of simultaneously applying a predetermined voltage to all the ultrasonic elements 11a to 11p. Here, “simultaneously applying” means continuously performing an operation of applying a voltage pulse to all the ultrasonic elements 11a to 11p while delaying the voltage pulse applied to the ultrasonic elements 11a to 11p by delay times.

In step S605, the voltage application element 20 executes a second operation of applying a predetermined voltage to each of the ultrasonic elements 11a to 11p at different timings. The second operation is configured such that the predetermined voltage is applied to only one ultrasonic element and a response value of a reflected wave of an ultrasonic wave transmitted from the one ultrasonic element is acquired with the acquisition element 30 at all the ultrasonic elements 11a to 11p, and this operation is repeated by the number of the ultrasonic elements.

As described above, for example, even when the distance from the surface of the plate-like member 210 to the adhesive layer at which the adhesive 230 is present is not known, the ultrasonic defect detection apparatus 100 of the present embodiment can appropriately measure the opening width of the defect DF formed at the adhesive layer by changing the DC voltage to be applied from the DC voltage application element 80 to the ultrasonic element so as to focus on the adhesive layer.

According to the ultrasonic defect detection apparatus 100 of the present embodiment, the adjustment mechanisms included in the ultrasonic elements 11a to 11p adjust the focal lengths of the respective ultrasonic elements, whereby the energy of the ultrasonic elements is concentrated on the focal points to obtain high response values, and the S/N ratio of the differential response value can be improved.

The ultrasonic defect detection apparatus and the ultrasonic defect detection method described in the embodiments described above are grasped as follows, for example.

An ultrasonic defect detection apparatus according to a first aspect of the present disclosure includes:
an ultrasonic array probe (10) including a predetermined number of ultrasonic elements arranged along a predetermined direction, each of the ultrasonic elements transmitting ultrasonic waves of a predetermined frequency to an inspection object (200) and receiving the ultrasonic waves of the predetermined frequency reflected by the inspection object;
a voltage application element (20) executing a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition element (30) acquiring a differential response value, the differential response value being a difference between a first response value of the ultrasonic waves of the predetermined frequency received by the ultrasonic array probe in the first operation and a second response value obtained by adding a plurality of response values of the ultrasonic waves of the predetermined frequency received by the ultrasonic array probe at different timings in the second operation; and
a measurement element (40) measuring an opening width of a defect in the inspection object based on a plurality of the differential response values acquired by the acquisition element when the voltage application element executes the voltage application operation at a plurality of the predetermined voltages having different voltage values.

According to the ultrasonic defect detection apparatus according to the first aspect of the present disclosure, when the voltage application element executes the voltage application operation including the first operation and the second operation, the acquisition element acquires a differential response value that is a difference between the first response value received by the ultrasonic array probe in the first operation and the second response value obtained by adding a plurality of response values received by the ultrasonic array probe in the second operation.

In the case of a defect exhibiting linear response characteristics in which the magnitude of a response value of reflected ultrasonic waves is proportional to the magnitude of the amplitude of ultrasonic waves transmitted from the ultrasonic elements, the differential response value is zero or a minute value. On the other hand, in the case of a defect exhibiting non-linear response characteristics in which the magnitude of a response value of reflected ultrasonic waves is not proportional to the magnitude of the amplitude of ultrasonic waves transmitted from the ultrasonic elements, the differential response value increases as the magnitude of the amplitude increases. The defect having non-linear response characteristics exhibits a linear response when the amplitude is small, but exhibits non-linear response characteristics when the amplitude increases.

Thus, the ultrasonic defect detection apparatus according to the first aspect of the present disclosure is configured to measure the opening width of a defect in the inspection object based on a plurality of the differential response values acquired by the acquisition element when the voltage application element executes the voltage application operation at a plurality of the predetermined voltages having different voltage values. For example, when the voltage application element executes the voltage application operation at the plurality of predetermined voltages while increasing the voltage value, the voltage value of the predetermined voltage at which the differential response value starts to increase is determined, whereby the opening width corresponding to the determined voltage value can be output as a measurement value.

An ultrasonic defect detection apparatus according to a second aspect of the present disclosure is the ultrasonic defect detection apparatus of the first aspect, further including a storage element storing a table associating a voltage value of the predetermined voltage applied by the voltage application element when the differential response value acquired by the acquisition element becomes a predetermined threshold value and the opening width of the defect in the inspection object, in which the voltage application element switches the voltage value of the predetermined voltage such that the differential response value acquired by the acquisition element becomes the predetermined threshold value and executes the voltage application operation a plurality of times, and the measurement element measures the opening width based on the voltage value of the predetermined voltage applied by the voltage application element when the differential response value acquired by the acquisition element becomes the predetermined threshold value and the table stored in the storage element.

According to the ultrasonic defect detection apparatus according to the second aspect of the present disclosure, the storage element stores the table associating the voltage value of the predetermined voltage applied by the voltage application element when the differential response value acquired by the acquisition element becomes the predetermined threshold value (e.g., a value reliably indicating that a non-linear response is exhibited) and the opening width of the defect in the inspection object. Then, the measurement element can measure the opening width based on the voltage value of the predetermined voltage applied by the voltage application element when the differential response value acquired by the acquisition element becomes the predetermined threshold value and the table stored in the storage element.

An ultrasonic defect detection apparatus according to a third aspect of the present disclosure is the ultrasonic defect detection apparatus of the first aspect or the second aspect, in which the second operation is an operation of applying the predetermined voltage to a first element group including odd-numbered elements from one end in the predetermined direction among the predetermined number of ultrasonic elements and a second element group including even-numbered elements from the one end in the predetermined direction among the predetermined number of ultrasonic elements at different timings.

According to the ultrasonic defect detection apparatus according to the third aspect of the present disclosure, each of a response value received by applying the predetermined voltage to the odd-numbered first element group and a response value received by applying the predetermined voltage to the even-numbered second element group is half a response value received by applying the predetermined voltage to all the elements. Thus, when the first response value received in the first operation exhibits non-linear response characteristics, the differential response value can be acquired such that each response value received when the predetermined voltage is applied to the first element group or the second element group exhibits linear response characteristics.

An ultrasonic defect detection apparatus according to a fourth aspect of the present disclosure is the ultrasonic defect detection apparatus of any one of the first to third aspects, in which the second operation is an operation of applying the predetermined voltage to each of the predetermined number of ultrasonic elements at different timings.

According to the ultrasonic defect detection apparatus according to the fourth aspect of the present disclosure, the predetermined voltage is applied to each of the predetermined number of ultrasonic elements at different timings, and the second response value is obtained by adding a response value received by each of the predetermined number of ultrasonic elements. The response value received by applying the predetermined voltage to each of the ultrasonic elements is (1/the predetermined number) of the response value received by applying the predetermined voltage to all the elements. Thus, when the first response value received in the first operation exhibits non-linear response characteristics, it is possible to improve the S/N ratio of the differential response value by making each response value received when the predetermined voltage is applied to each of the ultrasonic elements to reliably exhibit linear response characteristics.

An ultrasonic defect detection apparatus according to a fifth aspect of the present disclosure is the ultrasonic defect detection apparatus of the fourth aspect, in which each of the ultrasonic elements includes an adjustment mechanism that adjusts a focal length.

According to the ultrasonic defect detection apparatus according to the fifth aspect of the present disclosure, the adjustment mechanism adjusts the focal length of each of the ultrasonic elements, whereby the energy of the ultrasonic elements is concentrated on focal points to obtain high response values, and the S/N ratio of the differential response value can be improved.

An ultrasonic defect detection apparatus according to a sixth aspect of the present disclosure is the ultrasonic defect detection apparatus of the fifth aspect, in which the adjustment mechanism adjusts the focal length in accordance with a propagation time from when the ultrasonic element transmits ultrasonic waves to when the ultrasonic element receives the ultrasonic waves.

According to the ultrasonic defect detection apparatus according to the sixth aspect, since the adjustment mechanism adjusts the focal length in accordance with the propagation time from when the ultrasonic element transmits the ultrasonic waves to when the ultrasonic element receives the ultrasonic waves, for example, even when the distance from a surface of the inspection object to the defect is not known, the opening width of the defect can be appropriately measured by adjusting the focal length so as to focus on the defect.

An ultrasonic defect detection apparatus according to a seventh aspect of the present disclosure is the ultrasonic defect detection apparatus of any one of the first to the sixth aspects, further including an image creation element (60) that creates a C-scan image from the differential response value acquired by the acquisition element when the ultrasonic array probe is moved on the surface of the inspection object along a movement direction intersecting the predetermined direction.

According to the ultrasonic defect detection apparatus according to the seventh aspect of the present disclosure, by creating a C-scan image with the image creation element, an image of the inspection object along the movement direction can be displayed, making it possible to easily recognize a position in the movement direction at which a defect has occurred.

An ultrasonic defect detection method according to an eighth aspect of the present disclosure is an ultrasonic defect detection method for measuring an opening width of a defect in an inspection object with an ultrasonic defect detection apparatus, the ultrasonic defect detection apparatus including an ultrasonic array probe including a predetermined number of ultrasonic elements arranged along a predetermined direction, each of the ultrasonic elements transmitting ultrasonic waves of a predetermined frequency to the inspection object and receiving the ultrasonic waves of the predetermined frequency reflected by the inspection object, the ultrasonic defect detection method including:
a voltage application process of executing a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition process of acquiring a differential response value, the differential response value being a difference between a first response value of the ultrasonic waves of the predetermined frequency received by the ultrasonic array probe in the first operation and a second response value obtained by adding a plurality of response values of the ultrasonic waves of the predetermined frequency received by the ultrasonic array probe at different timings in the second operation; and
a measurement process of measuring the opening width of the defect in the inspection object based on a plurality of the differential response values acquired by the acquisition process when the voltage application process executes the voltage application operation at a plurality of the predetermined voltages having different voltage values.

According to the ultrasonic defect detection method according to the eighth aspect of the present disclosure, when the voltage application operation including the first operation and the second operation is executed in the voltage application process, the differential response value that is a difference between the first response value received by the ultrasonic array probe in the first operation and the second response value obtained by adding the plurality of response values received by the ultrasonic array probe in the second operation is acquired in the acquisition process.

In the case of exhibiting linear response characteristics in which the magnitude of a response value of reflected ultrasonic waves is proportional to the magnitude of the amplitude of transmitted ultrasonic waves, the differential response value is zero or a minute value. On the other hand, in the case of exhibiting non-linear response characteristics in which the magnitude of a response value of reflected ultrasonic waves is not proportional to the magnitude of the amplitude of transmitted ultrasonic waves, the differential response value increases as the magnitude of the amplitude increases. In the case of a defect having non-linear response characteristics in which a response value of received ultrasonic waves in not proportional to the magnitude of the amplitude of transmitted ultrasonic waves, a linear response is exhibited when the amplitude is small, but a non-linear response is exhibited when the amplitude increases.

Thus, the ultrasonic defect detection method according to the eighth aspect of the present disclosure is configured to measure the opening width of a defect in the inspection object based on a plurality of the differential response values acquired in the acquisition process when the voltage application operation is executed at a plurality of the predetermined voltages having different voltage values in the voltage application process. For example, when the voltage application operation is executed at the plurality of predetermined voltages while increasing the voltage value in the voltage application process, the voltage value of the predetermined voltage at which the differential response value starts to increase is determined, whereby the opening width corresponding to the determined voltage value can be output as a measurement value.

### REFERENCE SIGNS LIST

10 Ultrasonic array probe
11a, 11b, 11c, 11d, 11e, 11f, 11g, 11h, 11i, 11j, 11k, 11l, 11m, 11n, 11o, 11p
Ultrasonic element
20 Voltage application element
30 Acquisition element
40 Measurement element
50 Storage element
60 Image creation element
70 Image display element
80 DC voltage application element
100 Ultrasonic defect detection apparatus
200 Inspection object
210 Plate-like member
220 Plate-like member
230 Adhesive
A0, A1, A2 Amplitude
AR1, AR2, AR3, AR4 Area
DF, DF1, DF2, DF3, DF4 Defect
FD1, FD2, FD3 Focal length
Fd Differential response value
IM1, IM2, IM3, IM4, IM5 Image
Uw Ultrasonic wave
WD Width direction

1. An ultrasonic defect detection apparatus comprising:
an ultrasonic array probe including a predetermined number of ultrasonic elements arranged along a predetermined direction, each of the ultrasonic elements being configured to transmit ultrasonic waves of a predetermined frequency to an inspection object and receive the ultrasonic waves of the predetermined frequency reflected by the inspection object;
a voltage application element configured to execute a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition element configured to acquire a differential response value, the differential response value being a difference between a first response value of the ultrasonic waves of the predetermined frequency received by the ultrasonic array probe in the first operation and a second response value obtained by adding a plurality of response values of the ultrasonic waves of the predetermined frequency received by the ultrasonic array probe at different timings in the second operation; and
a measurement element configured to measure an opening width of a defect in the inspection object based on a plurality of the differential response values acquired by the acquisition element when the voltage application element executes the voltage application operation at a plurality of the predetermined voltages having different voltage values.

2. The ultrasonic defect detection apparatus according to claim 1, further comprising a storage element configured to store a table associating a voltage value of the predetermined voltage applied by the voltage application element when the differential response value acquired by the acquisition element becomes a predetermined threshold value and the opening width of the defect in the inspection object, wherein
the voltage application element switches the voltage value of the predetermined voltage such that the differential response value acquired by the acquisition element becomes the predetermined threshold value and executes the voltage application operation a plurality of times, and
the measurement element measures the opening width based on the voltage value of the predetermined voltage applied by the voltage application element when the differential response value acquired by the acquisition element becomes the predetermined threshold value and the table stored in the storage element.

3. The ultrasonic defect detection apparatus according to claim 1, wherein the second operation is an operation of applying the predetermined voltage to a first element group and a second element group at different timings, the first element group including odd-numbered elements from one end in the predetermined direction among the predetermined number of ultrasonic elements, the second element group including even-numbered elements from the one end in the predetermined direction among the predetermined number of ultrasonic elements.

4. The ultrasonic defect detection apparatus according to claim 1, wherein the second operation is an operation of applying the predetermined voltage to each of the predetermined number of ultrasonic elements at different timings.

5. The ultrasonic defect detection apparatus according to claim 4, wherein each of the ultrasonic elements includes an adjustment mechanism configured to adjust a focal length.

6. The ultrasonic defect detection apparatus according to claim 5, wherein the adjustment mechanism adjusts the focal length in accordance with a propagation time from when the ultrasonic element transmits ultrasonic waves to when the ultrasonic element receives the ultrasonic waves.

7. The ultrasonic defect detection apparatus according to claim 1, further comprising an image creation element configured to create a C-scan image from the differential response value acquired by the acquisition element when the ultrasonic array probe is moved on a surface of the inspection object along a movement direction intersecting the predetermined direction.

8. An ultrasonic defect detection method for measuring an opening width of a defect in an inspection object with an ultrasonic defect detection apparatus,
the ultrasonic defect detection apparatus comprising:
an ultrasonic array probe including a predetermined number of ultrasonic elements arranged along a predetermined direction, each of the ultrasonic elements being configured to transmit ultrasonic waves of a predetermined frequency to the inspection object and receive the ultrasonic waves of the predetermined frequency reflected by the inspection object,
the ultrasonic defect detection method comprising:
a voltage application process of executing a voltage application operation, the voltage application operation including a first operation of simultaneously applying a predetermined voltage to the predetermined number of ultrasonic elements, and a second operation of dividing the predetermined number of ultrasonic elements into a plurality of element groups and applying the predetermined voltage to each of the element groups at different timings;
an acquisition process of acquiring a differential response value, the differential response value being a difference between a first response value of the ultrasonic waves of the predetermined frequency received by the ultrasonic array probe in the first operation and a second response value obtained by adding a plurality of response values of the ultrasonic waves of the predetermined frequency received by the ultrasonic array probe at different timings in the second operation; and
a measurement process of measuring the opening width of the defect in the inspection object based on a plurality of the differential response values acquired in the acquisition process when the voltage application operation is executed at a plurality of the predetermined voltages having different voltage values in the voltage application process.
